(19) United States
(12) Patent Application Publication
(10) Pub. No.: US 2026/0009983 A1
(43) Pub. Date: Jan. 8, 2026

(54) ANAMORPHIC LENS

(71) Applicant: Glaswerk GmbH, Freiburg (DE)

(72) Inventors: Christoph Horneber, Lauf a. d. Pegnitz (DE); Elisabeth Siebert, Berlin (DE); Volker Türck, Berlin (DE); David Kellermann, Freiburg (DE); Viola Evang, Freiburg (DE)

(21) Appl. No.: 19/261,371

(22) Filed: Jul. 7, 2025

(30) Foreign Application Priority Data
Jul. 4, 2024 (DE) 102024119029.9

(51) Int. Cl. G02B 13/08; G02B 7/10; G02B 9/64

(52) U.S. Cl. CPC G02B 13/08; G02B 7/10; G02B 9/64

(57) ABSTRACT

According to one aspect of the present invention, there is provided an anamorphic objective lens having optical elements arranged along an optical axis in a sequence from an object side to an image side, the optical elements including: a first objective section arranged on the object side; a second objective section arranged on the image side; and a diaphragm arranged between the first and second objective sections, wherein the second objective section includes at least one astigmatizer.

The present invention relates to an anamorphic objective lens for use in the film industry and further relates to a method for adjusting an anamorphic objective lens, in particular a method for reducing manufacturing-induced imaging errors in anamorphic objective lenses.

### BACKGROUND

Anamorphic objective lenses are special camera lenses used in photography and film. They are characterized by their ability to typically compress the horizontal object field relative to the vertical object field, thereby creating a horizontally compressed image. Depending on the optical design, this effect can lead to a special visual style that is appreciated in various fields of application.

A fundamental characteristic of anamorphic objective lenses is the different image magnification in the vertical and horizontal directions. Typically, they compress the object field horizontally and/or stretch it vertically, resulting in object field aspect ratios such as 2.35:1 or 2.39:1 when using conventional image acquisition units with aspect ratios such as ˜1.18 (0.868″× 0.735″ image field—Cinemascope from 20th Century Fox). These different image ratios are achieved by the fact that an anamorphic objective lens has different focal lengths in two mutually orthogonal planes, each of which is parallel to the optical axis. As a result, such an objective lens has a lower degree of symmetry compared to conventional rotationally symmetrical lenses. Typically, anamorphic objective lenses exhibit a twofold mirror symmetry with respect to the aforementioned orthogonal planes. In the analysis of anamorphic objective lenses, it is common to align the optical axis along the z-axis of a three-dimensional Cartesian coordinate system. Furthermore, the alignment is carried out so that the xz and yz planes coincide with the aforementioned orthogonal symmetry planes.

The use of anamorphic objective lenses requires special equipment and expertise. After the image has been captured, the images must be post-processed, in particular optically or digitally desqueezed (also referred to as unsqueezed or dewarped herein), in order to restore the correct image aspect ratio. The anamorphic design of such objective lenses results in a number of special imaging properties. For example, depending on the design of the anamorphic objective lens, objects located outside the focal plane are rendered blurred, creating an elliptical circle of confusion. This effect is known as “oval bokeh” and is a desirable property of such objective lenses from an artistic and image design perspective.

EP 2535752 A1 discloses an anamorphic objective lens comprising at least a first objective section and at least a second objective section. Seen from an object to be imaged towards an image capture unit, the first objective section is arranged first, followed by the second objective section. An aperture or diaphragm is arranged between the first objective section and the second objective section. At least one first anamorphic optical element is arranged in the first objective section. Further anamorphic objective lenses are known from U.S. Pat. Nos. 10,126,533 B1, 2,890,622 A and 886,770 A.

In view of the use of anamorphic objective lenses to achieve the desired optical effects, it is important that the optical elements are of high quality and are precisely manufactured and arranged. Deviations in the production and assembly of the optical elements can lead to the specified image quality not being achieved as desired or the image being degraded by additional imaging errors. In particular, deviations in the radius of curvature of the cylindrical lenses usually used for compression and/or stretching lead to axial astigmatism in the overall system that can hardly be adjusted.

High quality requirements result in disproportionately increasing manufacturing costs. Additionally, restrictive specifications may exceed the technological capabilities of suppliers.

It is therefore an object of the present invention to provide an anamorphic lens that overcomes or significantly reduces the disadvantages of existing technologies. In particular, the invention aims to correct manufacturing-induced axial astigmatism or to extend the production tolerances.

### SUMMARY OF THE INVENTION

The present invention is defined in the independent claims. Optional features and embodiments are specified in the dependent claims and in the present disclosure.

According to a first aspect of the present invention, there is provided an anamorphic objective lens having optical elements arranged along an optical axis in a sequence from an object side to an image side, the optical elements comprising: a first objective section arranged on the object side; a second objective section arranged on the image side; and a diaphragm arranged between the first and second objective sections, wherein the second objective section comprises at least one astigmatizer.

The astigmatizer arranged in the second objective section on the image side of the diaphragm is suitable for adjusting the anamorphic objective lens. In particular, the astigmatizer can be used to compensate for manufacturing tolerances of the optical elements during the manufacture of the objective lens. Furthermore, astigmatism resulting from manufacturing and assembly tolerances of the optical elements in an anamorphic objective lens can be compensated for or reduced. Accordingly, the term astigmatizer in the present disclosure refers to an optical group which is suitable for compensating or reducing astigmatism as a whole. The astigmatizer also has the effect of breaking the mirror symmetry of the optical assembly.

In one embodiment, the astigmatizer is fixed in relation to the second objective section, in particular relative to the other optical elements of the second objective section, when the anamorphic objective lens is in its operational state. Specifically, the astigmatizer is fixed against displacement along the optical axis and/or rotation about the optical axis and/or tilting relative to the optical axis in the operational state of the anamorphic objective lens. In contrast, during an adjustment, i.e. prior to the anamorphic objective lens being put into operation, the astigmatizer can be adjusted in one or more of these degrees of freedom in order to correct undesirable imaging effects, in particular astigmatism, which can be caused by manufacturing tolerances of the individual elements of the anamorphic objective lens or by their assembly.

In one embodiment, an optical group arranged in the first objective section, specifically one or more focusing lens elements, is movable relative to the astigmatizer. In particular, the anamorphic objective lens comprises an adjustment device for focusing the lens during operation of the lens. The adjustment, specifically the displacement of a focusing lens along the optical axis of the anamorphic objective lens, does not result in a corresponding displacement of the astigmatizer. Rather, the focusing lens moves relative to the astigmatizer during focusing. In other words, the position of the astigmatizer along the optical axis is fixed with respect to a common reference point (e.g. an image plane, a camera body and/or a non-adjustable part of the lens housing), while the focusing lens is movable with respect to the same reference point. The astigmatizer is thus rotatable but not displaceable.

According to a second aspect of the present invention, an anamorphic objective lens is provided with optical elements arranged along an optical axis in a sequence from an object side to an image side, the optical elements comprising: a first objective section arranged on the object side; a second objective section arranged on the image side; a diaphragm arranged between the first and second objective sections; an adjustable focusing device, in particular a focusing device arranged in the first objective section and movable relative to the second objective section; and at least one astigmatizer which is fixed with respect to the second lens section, in particular with respect to the optical elements of the second objective section, in the operational state of the anamorphic objective lens.

According to this aspect of the invention, the astigmatizer can be arranged in the first objective section or in the second objective section. The astigmatizer is not accessible in the operational state of the anamorphic objective lens, i.e. in particular in the operating state of the anamorphic objective lens, and is fixed with respect to the other optical elements of the second objective section. In particular, the astigmatizer cannot be rotated or otherwise adjusted in relation to the other optical elements of the second objective section during operation of the anamorphic objective lens, e.g. when recording a video or image. Rather, the astigmatizer should enable the anamorphic objective lens to be adjusted during assembly, i.e. before being put into operation, and should no longer be adjustable after assembly or during operation. On the other hand, the astigmatizer can be movable relative to at least one of the optical groups of the first objective section, in particular focusing lenses. In other words, there is a movement/displacement of one or more focusing lenses arranged in the first lens section relative to the (fixed) astigmatizer.

In one embodiment, the first and second aspects are combined, i.e. the astigmatizer is arranged on the image side with respect to the optical aperture and is fixed and non-adjustable with respect to the second objective section during operation of the anamorphic lens. This arrangement enables particularly effective correction of undesirable image effects that can be caused by manufacturing tolerances.

In one embodiment, in which the anamorphic objective lens comprises an adjustment device for focusing during operation, the astigmatizer is decoupled from the adjustment device and cannot be adjusted or moved by actuating the adjustment device. In particular, the astigmatizer is decoupled from lenses that are adjusted for focusing purposes. The adjustment, in particular the displacement of a focusing lens or lens group along the optical axis of the anamorphic objective lens, therefore does not result in a corresponding adjustment or displacement of the astigmatizer. Rather, the focusing lens moves relative to the astigmatizer during focusing. In other words, the astigmatizer is fixed with respect to a common reference point (e.g., an image plane, a camera body and/or a non-adjustable part of the objective lens housing), while the focusing lens is movable with respect to the same reference point.

In one embodiment, the astigmatizer is arranged on the image side directly behind the diaphragm. In other words, no further optical element is arranged between the diaphragm and the astigmatizer.

In one embodiment, one or more anamorphic elements are arranged in the first objective section. The use of cylindrical lenses as anamorphic elements is particularly effective. Within this group, the cylindrical axes of the respective cylindrical lenses can be aligned parallel to the x- and/or y-axis (“crossed cylindrical lenses”).

In one embodiment, the anamorphic objective lens comprises an adjustment device for focusing the objective lens during operation, wherein the focusing device is arranged on the optical axis on the object side in the first objective section, and the anamorphic elements are arranged on the image side in the first objective section. The use of rotationally symmetrical lenses within the focusing device for focusing the anamorphic objective lens during operation is particularly effective.

In one embodiment, the anamorphic objective lens comprises an adjustment device for focusing the objective lens during operation, wherein the astigmatizer is decoupled from the adjustment device and cannot be adjusted or moved by actuating the adjustment device. In particular, the astigmatizer is decoupled from lenses that are adjusted for the purpose of focusing. The adjustment, in particular the displacement of a focusing lens along the optical axis of the anamorphic objective lens, therefore does not lead to a corresponding adjustment or displacement of the astigmatizer. Rather, the focusing lens moves relative to the astigmatizer during focusing. In other words, the astigmatizer is fixed with respect to a common reference point (e.g., an image plane, a camera body and/or a non-adjustable part of the lens housing), while the focusing lens is movable with respect to the same reference point.

In one embodiment, the astigmatizer can be adjusted during assembly or adjustment of the anamorphic objective lens before the anamorphic objective lens is ready for operation and can be moved and/or rotated and/or tilted in relation to the second objective section, in particular relative to the other optical elements of the second objective section. The various adjustment options can be used to correct different optical errors that can arise due to manufacturing tolerances.

In one embodiment, the anamorphic objective lens comprises an astigmatizer with several optical elements that are fixed in relation to each other in the operational state of the anamorphic objective lens. In particular, the astigmatizer may comprise a cylindrical lens with positive refractive power (“positive cylindrical lens”) and a cylindrical lens with negative refractive power (“negative cylindrical lens”), e.g. a plano-convex and a plano-concave cylindrical lens. The cylindrical lenses can be adjustable relative to each other, in particular rotatable, during assembly or adjustment of the anamorphic objective lens, i.e. before the lens is in its operational state. The cylindrical lenses can be arranged in such a way that their cylindrical axes are perpendicular to the optical axis and that the optical elements are rotated about the optical axis.

The refractive powers of the cylindrical lenses may cancel each other out in their nominal position and have opposite signs (+/−). During assembly or adjustment, the cylindrical lenses can first be rotated relative to each other about the optical axis and brought into a desired position relative to each other. Additionally, the two cylindrical lenses can be jointly rotated about the optical axis and brought into a desired position. For example, the two cylindrical lenses may be rotated relative to each other by a small angle (<5°) in order to compensate for manufacturing tolerances, in particular manufacturing tolerances of cylindrical lenses outside the astigmatizer, when adjusting the lens. The angle corresponds to the angle enclosed by the two cylinder axes of the cylindrical lenses in a plane orthogonal to the optical axis. In addition, the two cylindrical lenses can be rotated together by a larger angle (<45°) around the optical axis in order to compensate for manufacturing-related overall orientation errors of the anamorphic elements.

In one embodiment, the cylindrical lenses of the astigmatizer are arranged sequentially along the optical axis and orthogonal to it. In particular, the two cylindrical lenses can be arranged directly in relation to each other with a small air gap between them. The air gap can be selected such that the distance is as small as possible on the one hand and on the other hand allows the cylindrical lenses to be rotated relative to each other for the purpose of adjustment.

According to a further aspect of the present invention, there is provided an optical system comprising: an anamorphic objective lens having features according to the present disclosure and an image capture unit.

According to a further aspect of the present invention, there is provided a method for adjusting an anamorphic objective lens having features according to the present disclosure, the method comprising: one or more assembly steps prior to making the lens ready for operation, in which the optical elements of the anamorphic objective lens are mounted, in which the astigmatizer is first mounted and then adjusted to reduce or eliminate axial astigmatism, and in which the astigmatizer and/or the elements of the astigmatizer are fixed after the adjustment is completed.

### BRIEF DESCRIPTION OF THE DRAWINGS

The invention is described in more detail below with reference to exemplary embodiment, but is not limited to these exemplary embodiments. Further embodiments result from combining the features of individual or multiple claims with one another and/or in combination with individual or multiple features of the embodiments.

In the drawings:

FIG. 1 shows a sectional view of an anamorphic objective lens system in the xz-plane according to an embodiment of the present invention;

FIG. 2 shows sectional views of the anamorphic objective lens system of FIG. 1 in the xz-plane (top) and the yz-plane (bottom);

FIG. 3 shows isometric views of the astigmatizer of FIG. 1 in nominal position, counter-rotated by 5° and additionally jointly rotated by 30°; and

FIG. 4 shows a flow chart, illustrating steps for adjusting an anamorphic objective lens according to an embodiment of the invention.

### DESCRIPTION OF EXEMPLARY EMBODIMENTS

In the following description of various embodiments of the invention, elements having the same function are given corresponding reference signs even if they differ in design or configuration.

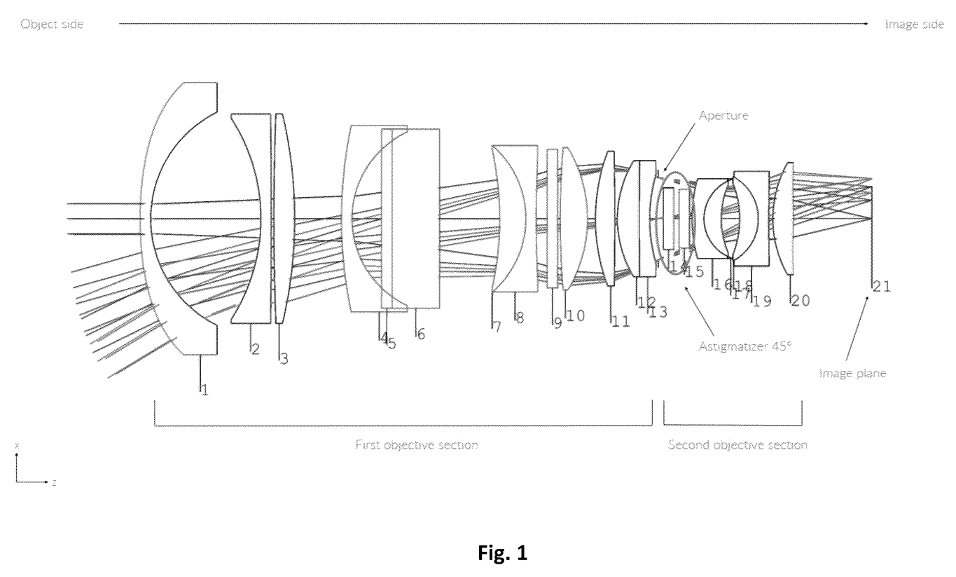

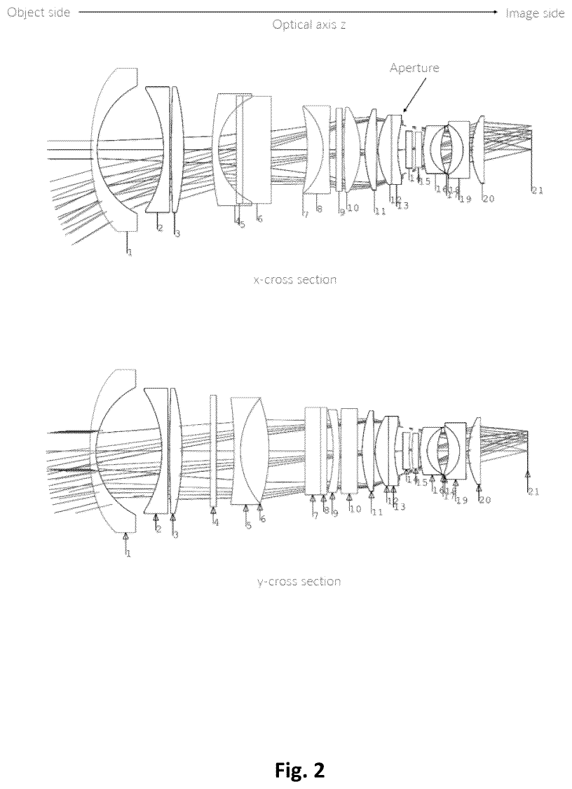

FIGS. 1 and 2 show an anamorphic objective lens according to one embodiment of the present invention. FIG. 1 shows a section through the anamorphic objective lens in the xz plane. FIG. 2 shows sections through the xz and yz planes. In this context, the optical axis is aligned along the z-axis of a three-dimensional Cartesian coordinate system, with the xz and yz planes coinciding with two mutually orthogonal planes, each of which is parallel to the optical axis.

When an image is captured by such a lens, the image is compressed on the horizontal axis (x) by a factor greater than 1 (e.g. 2). On the object side, such a lens comprises at least one rotationally symmetric front lens and a further lens or lens group that can be moved along an optical axis for focusing. An anamorphic lens group, e.g. a cylindrical lens group, is arranged on the image side of the rotationally symmetrical lens group. Within this group, the cylinder axes of the respective cylinder lenses can be aligned parallel to the x- and/or y-axis (“crossed cylinder lenses”). This is followed by a base lens comprising rotationally symmetrical lenses, a diaphragm and an astigmatizer.

The astigmatizer comprises one cylindrical lens with positive refractive power and one with negative refractive power (e.g. one plano-convex and one plano-concave cylindrical lens), the cylindrical axes of which are aligned perpendicular to the optical axis. The two lenses form a functional group and their refractive powers have almost identical magnitudes but different signs. The astigmatizer has a neutral position in which the cylindrical axes of both cylindrical lenses are aligned parallel to each other. In this position, the astigmatizer essentially resembles a plane-parallel plate. Tolerances in the manufacturing and assembly of the cylindrical lenses can lead to axial astigmatism of the overall system, in which the astigmatic line foci are parallel to the x and y axes. This axial astigmatism can be compensated for by the astigmatizer by first rotating the two cylindrical lenses around the optical axis so that the cylindrical axes form an angle of 45° with the x-axis. The positive and negative cylindrical lenses are then rotated in opposite directions around the optical axis by a small amount. This creates an axial astigmatism that is oriented along the x and y axes. Such an adjustment changes the optical effect of the astigmatizer and can thus reduce or eliminate the production-related axial astigmatism of the overall system. In a further step, the astigmatizer can be rotated around the optical axis to further reduce the effects of the manufacturing tolerances of the cylindrical lenses. The astigmatizer adjusted in this way further reduces the symmetry of the optical system. An anamorphic objective lens set up in this way now only has 180° rotational symmetry around the optical axis. In particular, there is no longer any mirror symmetry with respect to the xz and xz planes.

The anamorphic objective lens shown here thus combines a rotationally symmetrical front for focusing and crossed cylindrical lenses with an astigmatizer. This arrangement makes it possible to use an astigmatizer in an anamorphic objective lens that only serves to compensate for manufacturing tolerances during assembly and is no longer variable after adjustment.

The lens arrangement of the anamorphic objective lens is described in more detail below with reference to FIGS. 1 and 2. The lenses are described from left to right, i.e. from the object side to the image side along the optical axis z.

The anamorphic objective lens comprises a first objective section on the object side and a second objective section on the image side, which are separated from each other by a diaphragm. In particular, the first objective section comprises a group of rotationally symmetrical lenses 1, 2 and 3. This lens group is used to focus the image and is therefore adjustable. For this purpose, the lens 3 can be displaced along the optical axis. Lens 3 is thus configured to be movable along the optical axis. Focusing an image (object?) using a first adjustable lens group arranged on the object side is known per se and is therefore not described further.

A group of lenses 4-10 is arranged on the image side of the anamorphic objective lens 3. This group of lenses 4-10 forms an anamorphic lens group and contains crossed cylindrical lenses. In other words, at least one cylindrical lens effective in the x-direction is provided, and at least one cylindrical lens effective in the y-direction is provided. This lens group produces an anamorphic imaging effect. The generation of an anamorphic image effect is also known per se and is not described further.

A group of rotationally symmetrical lenses 11-13 is arranged on the image side of the lens 10. Thus, the first objective section comprises three lens groups, namely a first group arranged on the object side with the lenses 1-3, a second centrally arranged anamorphic lens group with the lenses 4-10, and a third group of rotationally symmetrical lenses 11-13 arranged on the image side. The number, configuration and arrangement of the individual lenses in the respective lens groups shown are merely exemplary. Each of the lens groups comprises at least one lens of the type described for that lens group. That is, the object-side lens group of the first objective section comprises at least one rotationally symmetrical lens. The centrally arranged lens group of the first objective section comprises at least one anamorphic lens element. The lens group of the first objective section arranged on the image side comprises at least one rotationally symmetrical lens. In an alternative embodiment, the first objective section comprises only two lens groups, in particular the object-side group for focusing the image and the central anamorphic lens group.

An aperture or diaphragm is arranged on the image side of the first objective section. The diaphragm is thus arranged between the first and second objective sections. The diaphragm is designed as an iris diaphragm, for example, which has an adjustable aperture.

An astigmatizer is arranged on the image side of the diaphragm.

A further group of rotationally symmetrical lenses 16-20 is arranged between the cylindrical lenses 14 and 15 and the image plane 21. In other words, the second objective section comprises two lens groups, namely a fixed (and only adjustable for alignment) group of cylindrical lenses 14, 15 and a group of rotationally symmetrical lenses 16-20. The present disclosure is not limited to the number, configuration and arrangement of the lenses of the second objective section as shown. For example, the astigmatizer may include additional cylindrical lenses that are adjustable during calibration and fixed during proper operation. The group of lenses 16-20 comprises at least one rotationally symmetrical lens.

The external surfaces of the lenses 1 and 20 on the object side and image side can be formed by aspherical surfaces.

In summary, the anamorphic objective lens comprises two objective sections, in particular an object-side first objective section and an image-side second objective section, which are separated from one another by a diaphragm. The lenses within the two objective sections can be subdivided into lens groups or functional groups according to form and function as follows:
1. Rotationally symmetric front group (spherical, aspherical, planar or diffractive) for focusing. This group can be formed by two or more rotationally symmetric lenses. At least one of the lenses is moved for focusing. In one embodiment, this is not the first lens on the object side. As described above, the astigmatizer is not moved during focusing.
2. Anamorphic lens group comprising multiple cylindrical lenses. The lenses can be effective in the x- and y-directions. The lenses may also have planar surfaces and/or rotationally symmetric surfaces. In one embodiment, one or more cylindrical surfaces effective in the x-direction are provided, as well as one or more cylindrical surfaces effective in the y-direction.
3. Base lens: The base lens comprises the aperture and the astigmatizer. The base lens can comprise rotationally symmetrical, cylindrical, planar and/or free-form lenses.
4. Astigmatizer: The astigmatizer comprises two lenses, each of which has at least one cylindrical surface. In particular, the surfaces of these two lenses facing each other are cylindrical and have opposite refractive powers. The magnitude may or may not be identical. There is a small spacing between the lenses to allow rotation about the optical axis relative to each other. In the initial position, both lenses are oriented orthogonal to the optical axis and parallel to each other, but are rotated by 45° abound the optical axis Z in relation to the x-axis.

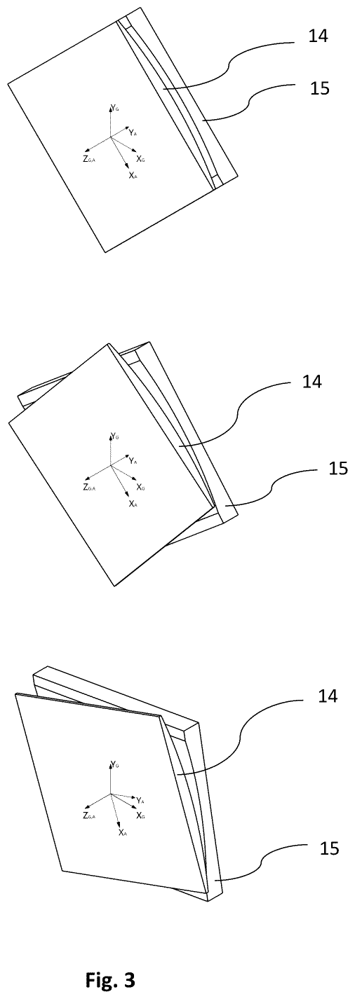

As shown in FIG. 3, both cylindrical lenses can be rotated relative to each other when adjusting the anamorphic objective lens so that the angle bisector between the two lens apexes YA is still at an angle of 45° to the x-axis (here X_{G}), but the two lenses are rotated by the same amount in different directions. Alternatively, the cylindrical lenses of the astigmatizer can be rotated together about the optical axis z (here Z_{GA}) in any direction, so that their axes are no longer exactly at a 45° angle to the x-axis. According to a further embodiment, the cylindrical lenses can be rotated against each other about z, whereby the angle bisector between the two lens apexes remains at an angle of 45° to the x-axis. The two cylindrical lenses can then be rotated together about the optical axis z. According to a further embodiment, the cylindrical lenses can be jointly rotated about the optical axis z and then against each other, with the bisector between the two lenses remaining in the position that the lenses had after the joint rotation about axis z.

In the present disclosure, a distinction is made between two states of the anamorphic objective lens, namely a state during assembly or adjustment, and the state of ready-to-operate position. The adjustment usually takes place before the anamorphic objective lens is put into operation, i.e. before the anamorphic objective lens is handed over to or used by a user. The adjustment can be part of the assembly of the anamorphic objective lens or complete the assembly. During assembly, the individual parts of the anamorphic objective lens are put together. Once assembly and adjustment are complete, the anamorphic objective lens is ready for use. In subsequent operation, the anamorphic objective lens is attached to an image capture unit (e.g. a camera) and can be used to capture images or films.

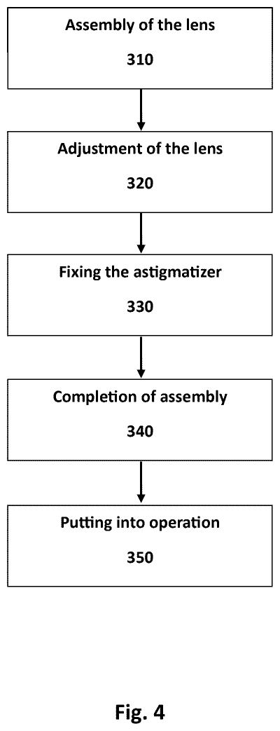

FIG. 4 shows the steps for adjusting and putting into operation an anamorphic objective lens according to FIGS. 1, 2 and 3. In a step 310, the components of the anamorphic objective lens are assembled. In particular, an astigmatizer is mounted on the image side behind the aperture. As already described, such an astigmatizer can be formed by two cylindrical lenses.

In a step 320, the anamorphic objective lens is adjusted. In particular, the astigmatizer is adjusted. In an embodiment of the astigmatizer by means of two cylindrical lenses, these are first rotated relative to each other and then jointly rotated about the optical axis, as described above. This step is carried out or repeated until the astigmatizer is adjusted in such a way that possible optical imaging errors, e.g. axial astigmatism, are eliminated or reduced to a desired level. Alternatively, however, the astigmatizer can also be adjusted in such a way that certain optical aberrations are deliberately produced or amplified, e.g. to achieve certain desired optical effects. The inspection of the image can be carried out by measuring equipment or by a user.

In a step 330, the astigmatizer is fixed. In one embodiment, when the astigmatizer is formed by two cylindrical lenses, these lenses are fixed both with respect to the optical axis and also relative to each other. This completes the adjustment. In a step 340, the assembly as a whole can thus also be completed. In a step 350, the anamorphic objective lens can be put into operation. During operation, the astigmatizer is fixed and cannot be adjusted.

Steps 310-340 are generally carried out at the factory, while step 350 is carried out by the end user. In one embodiment, the anamorphic objective lens can also be taken out of operation at a later time, readjusted (steps 320 and 330) and put back into operation (step 350).

Terms and features according to exemplary embodiments of the invention are explained below.

Object side: The side of an objective lens facing the object to be imaged, opposite to the image sensor or camera. Light enters the objective lens from the object side. In graphical representations of the optical system, the object side is shown on the left and the image side on the right, so that the light path proceeds from left to right.

Image side: The side of the objective lens facing the image sensor or camera. Light exits on the image side and forms an image of the captured object on the image sensor or film. In graphical representations of the optical system, the object side is shown on the left and the image side on the right, so that the light path proceeds from left to right.

x-, y-, z-axis: Axes of a Cartesian coordinate system used in describing an objective lens or lens elements. According to widely used convention, the z-axis extends along the optical axis of the objective lens. The x- and y-directions are perpendicular thereto, with the x-direction oriented parallel to the horizon. Thus, the x- and y-axes are commonly referred to as “horizontal” and “vertical,” respectively.

Rotationally symmetrical lenses (lens surfaces): Lenses or lens surfaces in which the optical axis is also an axis of rotation with respect to which the surface exhibits rotational symmetry. Rotation by any angle around this axis maps the lens or surface onto itself. Such lenses or surfaces can be planar, spherical, or aspherical. The term “spherical” may be understood in contrast to cylindrical shaping and includes rotationally symmetric aspherical lens or surface forms as well as planar surfaces.

Anamorphic lens surfaces: Lens surfaces having different curvatures in two orthogonal sectional directions (typically the xz- and yz-plane). These can be cylindrical or toroidal surface shapes. Additionally, forms of non-circular cylinders may be used, sometimes referred to as “acyindrical surfaces,” which derive from cylinders with non-circular (e.g., elliptical) bases. Furthermore, freeform surfaces may also be understood under this definition, in particular freeform surfaces exhibiting mirror symmetry with respect to the xz- and yz-planes. Among anamorphic lens surfaces, cylindrical lens surfaces (both circular and non-circular) are of particular importance, as they exhibit no curvature along a distinguished axis, which may be referred to as the cylinder axis, cylinder vertex line, or ridge line.

Anamorphic lenses: Lenses having at least one surface formed by an anamorphic lens surface. The opposite side may likewise have an anamorphic surface shape or may be spherical or planar as described above. This category primarily includes cylindrical lenses (both circular and non-circular). These can be plano-cylindrical with one cylindrical and one planar surface, or bi-cylindrical with two cylindrical surfaces. In the bi-cylindrical form, the cylinder axes of the two lens surfaces may be aligned parallel or perpendicular to one another.

Anamorphic lens group: Lens groups within an optical system whose function is to compress or expand the image may be referred to as anamorphic lens groups. Such a group may include lenses with cylindrical surfaces whose cylinder axes are all parallel to one another and either parallel to the x- or y-axis, or may include lenses whose cylinder axes are oriented orthogonally to one another and parallel to the x- and y-axes, respectively. The first arrangement is referred to as parallel, the second as orthogonal or crossed.

Anamorphic objective lens: An objective lens having one or more anamorphic lens groups. The lens produces an image of the captured object that is compressed in one direction (e.g., horizontally). It has different focal lengths in the horizontal and vertical orientations. In cinematographic applications, anamorphic lenses compress the object horizontally, resulting in a distorted or squeezed image. This enables the capture of scenes with a greater horizontal extent than would be possible with a conventional rotationally symmetric lens. To display such an image, it must first be “desqueezed”, which can be done, for example, by using a projection objective lens with an anamorphic magnification factor inverse to that of the capture objective lens, or digitally in post-production.

Optical group: one or more optical elements that form an optically or mechanically identifiable component of the system.

Spherical front group for focusing: A group of rotationally symmetric lenses (about the z-axis) forming the first lens group of the optical system as seen from the object side, wherein at least one of the lenses is displaced along the z-axis for focusing.

Base lens: spherical/rotationally symmetrical objective lens with a diaphragm, which can usually be arranged between the last anamorphic group and the image plane.

Bokeh: Objects located outside the plane of focus are imaged as blurred by an objective lens. Point-shaped objects are rendered as circles of confusion. Depending on the properties of the objective lens, imaging conditions, and location within the image field, this circle of confusion may exhibit different structures and shapes, creating various visual impressions. The term “bokeh” generally refers to the aesthetic quality or rendering of the out-of-focus regions of an image. In the present context, the term describes the visual quality of individual circles of confusion produced under certain defocused imaging conditions in specific areas of the image field. Besides the brightness distribution within the circle of confusion, its geometric boundary shape is also relevant. In classical rotationally symmetric objective lenses, this shape is typically circular. Elliptical boundary shapes may also occur, with their major axes oriented parallel or perpendicular to the image circle. In anamorphic objective lenses with the anamorphic lens group arranged on the object side of the aperture, exclusively elliptical circles of confusion are formed, with the major axis of the ellipse typically aligned parallel to the y-axis. As a result, these elliptical circles of confusion are uniformly oriented throughout the image, producing a specific anamorphic bokeh effect. This effect, known as “oval bokeh,” is a desired characteristic of anamorphic objective lenses from an artistic and image design perspective.

Mumps: An undesirable change in the compression factor of the objective lens during focusing, resulting in objects being rendered wider or narrower than they actually are after optical or digital desqueezing.

Astigmatizer: This term generally refers to an optical group comprising two lenses having cylindrical surfaces with opposite refractive powers (the magnitude may or may not be identical), wherein the cylinder axes are oriented parallel to each other and orthogonal to the optical axis in the nominal position, but are rotated by 45° about the optical axis relative to the x-axis. In the initial position, the cylinder axes of both lenses lie along the bisector between the x- and y-planes.

According to embodiments of the present invention, the nominal position is as described above. The astigmatizer is adjusted during assembly and produces an axial astigmatism that compensates for the axial astigmatism of the lens caused by manufacturing and assembly tolerances. Each of the two lenses comprises at least one cylindrical surface. The opposite side may be planar, spherical or cylindrical. These are cylindrical lenses with opposite refractive power, i.e., with positive and negative refractive power. One cylindrical surface of one lens with positive refractive power and one cylindrical surface of the other lens with negative refractive power face each other. During assembly and/or adjustment, the two cylindrical lenses can be rotated in opposite directions around the z-axis. In addition, the two cylindrical lenses can be rotated together by a few degrees around the optical axis (the cylindrical axes are no longer congruent with the bisector between the x and y planes). Both adjustment steps are possible individually and in combination. This reduces optical errors that may be caused by manufacturing tolerances. The adjustment is carried out once after the anamorphic objective lens has been assembled; the positions of the astigmatizer lenses are fixed for operation (in the operating state). The astigmatizer is positioned in the base lens between the diaphragm and the image plane, allowing smaller lenses with corresponding cost and weight savings.

By rotation relative to the astigmatizer is meant a rotation about the z-axis (optical axis), wherein the cylinder axes of the two involved lenses maintain their orientation orthogonal to the z-axis.

The foregoing explanations of terms and features and the description of exemplary embodiments are intended solely to facilitate understanding of the present disclosure and are not to be construed as limiting the invention, which is defined by the claims.

1. An anamorphic objective lens comprising optical elements arranged along an optical axis in a sequence from an object side to an image side, the optical elements comprising:
a first objective section arranged on the object side;
a second objective section arranged on the image side; and
a diaphragm disposed between the first and second objective sections,
wherein the second objective section comprises at least one astigmatizer for modifying or reducing or eliminating astigmatic imaging effects.

2. The anamorphic objective lens according to claim 1, wherein the astigmatizer is fixed, in the ready-to-operate state of the objective lens, with respect to the second objective section, in particular with respect to the other optical elements of the second objective section.

3. The anamorphic objective lens according to claim 1, wherein an optical group arranged in the first objective section, in particular one or more focusing lenses (1-3), is movable relative to the astigmatizer.

4. The anamorphic objective lens according to claim 1, comprising one or more anamorphic elements (4-10) arranged in the first objective section, in particular one or more cylindrical lenses, and in particular multiple cylindrical lenses arranged crossed with respect to each other.

5. The anamorphic objective lens according to claim 4, wherein the focusing device is arranged on the object side in the first objective section, and wherein the anamorphic elements (4-10) are arranged on the image side in the first objective section.

6. The anamorphic objective lens according to claim 1, comprising an adjustment device for focusing the anamorphic objective lens during operation, wherein the astigmatizer is decoupled from the focusing device and is not adjustable or movable by actuation of the adjustment device.

7. The anamorphic objective lens according to claim 1,
wherein the astigmatizer is adjustable and movable and/or rotatable and/or tiltable for compensating shape and/or positional tolerances prior to putting into operation the anamorphic objective lens, and/or
wherein the astigmatizer is fixed in the operating state of the anamorphic objective lens with respect to displacement along the optical axis and/or with respect to rotation about the optical axis and/or with respect to tilting on the optical axis.

8. The anamorphic objective lens according to claim 1, comprising multiple astigmatizers or astigmatizer elements (14, 15) that are fixed relative to each other during operation of the anamorphic objective lens.

9. The anamorphic objective lens according to claim 1, wherein the astigmatizer comprises a cylindrical lens with positive refractive power, in particular a plano-convex cylindrical lens, and a cylindrical lens with negative refractive power, in particular a plano-concave cylindrical lens.

10. The anamorphic objective lens according to claim 9, wherein the cylindrical lenses of the astigmatizer are adjustable relative to one another, in particular rotatable about the optical axis, during assembly or adjustment of the objective lens, before the objective lens is put into operation.

11. The anamorphic lens according to claim 9, wherein the refractive powers of the cylindrical lenses of the astigmatizer substantially cancel each other out in their nominal position and have opposite signs.

12. The anamorphic objective lens according to claim 9, wherein the cylindrical lenses of the astigmatizer are arranged sequentially and spaced apart from each other along the optical axis.

13. An optical system comprising:
an anamorphic objective lens according to claim 1; and
an image capture unit.

14. An anamorphic objective lens having optical elements arranged along an optical axis in a sequence from an object side to an image side, the optical elements comprising:
a first objective section arranged on the object side;
a second objective section arranged on the image side;
a diaphragm arranged between the first and second objective sections;
an adjustable focusing device, in particular a focusing device arranged in the first objective section and movable relative to the second objective section; and
at least one astigmatizer for modifying or reducing or eliminating astigmatic imaging effects and which, during operation of the anamorphic objective lens, is fixed with respect to the second objective section, in particular with respect to the optical elements of the second objective section.

15. The anamorphic objective lens according to claim 14, wherein the astigmatizer is arranged on the image side of the optical aperture in the second objective section.

16. The anamorphic objective lens according to claim 14, comprising one or more anamorphic elements (4-10) arranged in the first objective section, in particular one or more cylindrical lenses, and in particular multiple cylindrical lenses arranged crossed with respect to each other.

17. The anamorphic objective lens according to claim 16, wherein the focusing device is arranged on the object side in the first objective section, and wherein the anamorphic elements (4-10) are arranged on the image side in the first objective section.

18. The anamorphic objective lens according to claim 14, comprising an adjustment device for focusing the anamorphic objective lens during operation, wherein the astigmatizer is decoupled from the focusing device and is not adjustable or movable by actuation of the adjustment device.

19. The anamorphic objective lens according to claim 14,
wherein the astigmatizer is adjustable and movable and/or rotatable and/or tiltable for compensating shape and/or positional tolerances prior to putting into operation the anamorphic objective lens, and/or
wherein the astigmatizer is fixed in the operating state of the anamorphic objective lens with respect to displacement along the optical axis and/or with respect to rotation about the optical axis and/or with respect to tilting on the optical axis.

20. The anamorphic objective lens according to claim 14, comprising multiple astigmatizers or astigmatizer elements (14, 15) that are fixed relative to each other during operation of the anamorphic objective lens.

21. The anamorphic objective lens according to claim 14, wherein the astigmatizer comprises a cylindrical lens with positive refractive power, in particular a plano-convex cylindrical lens, and a cylindrical lens with negative refractive power, in particular a plano-concave cylindrical lens.

22. The anamorphic objective lens according to claim 21, wherein the cylindrical lenses of the astigmatizer are adjustable relative to one another, in particular rotatable about the optical axis, during assembly or adjustment of the objective lens, before the objective lens is put into operation.

23. The anamorphic lens according to claim 21, wherein the refractive powers of the cylindrical lenses of the astigmatizer substantially cancel each other out in their nominal position and have opposite signs.

24. The anamorphic objective lens according to claim 21, wherein the cylindrical lenses of the astigmatizer are arranged sequentially and spaced apart from each other along the optical axis.

25. An optical system comprising:
an anamorphic objective lens according to claim 14; and
an image capture unit.

26. A method for adjusting an anamorphic objective lens, the method comprising:
one or more assembly steps before putting the lens into operation, in which the optical elements of the lens are mounted (310), in which the astigmatizer is first mounted and then adjusted (320) to modify or reduce or eliminate astigmatic imaging effects, and in which the astigmatizer and/or the elements of the astigmatizer are fixed (330) after the adjustment is completed.
